(19) United States
(12) Patent Application Publication
(10) Pub. No.: US 2012/0191291 A1
(43) Pub. Date: Jul. 26, 2012

(54) AFTERMARKET TELEMATICS SYSTEM AND METHOD FOR CONTROLLING A COMMUNICATIVELY PAIRED DEVICE

(75) Inventors: KEVIN R. KRAUSE, PLYMOUTH, MI (US); RUSSELL A. PATENAUDE, MACOMB TOWNSHIP, MI (US); DANIEL C. McGARRY, OXFORD, MI (US); KEVIN W. OWENS, STERLING HEIGHTS, MI (US); NICHOLAS J. PEARISO, OAK PARK, MI (US)

(73) Assignee: GENERAL MOTORS LLC, DETROIT, MI (US)

(21) Appl. No.: 13/011,638

(22) Filed: Jan. 21, 2011

(51) Int. Cl. G06F 7/00

(52) U.S. Cl. 701/29.6; 701/30.6

(57) ABSTRACT

A method for controlling a communicatively paired device for use with a vehicle (“ATU”) includes, but is not limited to, the steps of detecting a first power state of the vehicle using a vehicle communication interface (“VCI”) that is communicatively coupled to a communication bus on the vehicle, transmitting a wireless signal corresponding to the first power state from the VCI to the communicatively paired device, and altering a second power state of the communicatively paired device to correspond with the first power state.

### TECHNICAL FIELD

The technical field generally relates to vehicles, and more particularly relates to an aftermarket telematics system for use with a vehicle and a method for controlling an aftermarket telematics unit.

### BACKGROUND

Telematics services are services that are provided by a call center to a vehicle and/or to the operator of a vehicle that relate to various needs of the vehicle or the operator. Telematics services commonly include, but are not limited to, the remote monitoring of vehicle maintenance needs, the provision of turn by turn navigation guidance, the coordination of emergency services during vehicle emergencies, the provision of door unlock services when the vehicle's owner is locked out of the vehicle, and the provision of theft tracking services after a vehicle has been stolen, to name just a few.

A telematics service system conventionally includes a telematics unit mounted to the vehicle, a call center located remotely from the vehicle, and a communication network that communicatively connects the two. The telematics unit is configured to communicate with both the call center and a communication bus on the vehicle that communicatively links many of the vehicle's various subsystems (this is sometimes referred to as a “vehicle bus”). By virtue of its communicative connection to both the call center and the communication bus, the telematics unit is capable of communicating the vehicle's status to the call center.

Historically, the telematics unit has been embedded in the vehicle (i.e., mounted to the vehicle during vehicle assembly) and is therefore available to the operator throughout the operator's ownership of the vehicle. Embedded telematics units may have a direct connection to the communication bus on the vehicle. This direct connection to the communication bus allows an embedded telematics unit to determine, among other things, when the vehicle is powered on and when the vehicle is powered off Knowing the vehicle's power state allows an embedded telematics unit to power on when the vehicle is powered on and to enter a standby-mode when the vehicle is powered off. In a known approach, while in standby-mode, a majority of the embedded telematics unit's subsystems are turned off to avoid draining vehicle's battery while a relatively small number of subsystems are configured to either remain on or to turn on periodically for relatively short intervals. This enables the embedded telematics unit to provide certain vehicle-related services even while the vehicle is powered down.

Because of the popularity of telematics services, aftermarket telematics units are beginning to enter the market place. Such aftermarket telematics units make it possible for drivers of vehicles that lack an embedded telematics unit to, nevertheless, receive some or all of the available telematics services. An aftermarket telematics unit may be mounted to the vehicle and wired into the vehicle's electrical system or battery to draw the power that it needs to operate. Unlike an embedded telematics unit, an aftermarket telematics unit is not wired into the communication bus on the vehicle and therefore cannot rely on direct communications with the communication bus to determine when the vehicle is powered on and when the vehicle is powered off.

To avoid excessive drain of the vehicle's battery, it is desirable to have the aftermarket telematics unit powered on when the vehicle is powered on and to have the aftermarket telematics in a standby-mode (or in some cases, powered down further to an off-mode wherein all subsystems or nearly all subsystems are completely powered down) when the vehicle is powered off Without a direct connection to the communication bus, the aftermarket telematics unit needs another way to determine when the vehicle is powered on and when the vehicle is powered off. Some existing systems/methods for determining the power state of the vehicle rely on monitoring spikes and/or drops in the voltage of the vehicle's battery. While this is satisfactory, there is room for improvement.

### SUMMARY

Various examples of a communicatively paired device, including, but not limited to aftermarket telematics units, and various examples of methods for controlling such a device are disclosed herein.

In one non-limiting example, the method includes, but is not limited to, detecting a first power state of the vehicle using a vehicle communication interface that is communicatively coupled to a communication bus on the vehicle. The method further includes transmitting a wireless signal that corresponds to the first power state from the vehicle communication interface to a communicatively paired device. The method still further includes altering a second power state of the aftermarket telematics unit to correspond with the first power state.

In another non-limiting example, the method includes, but is not limited to, detecting a first power state of the vehicle using a first method. The method further includes detecting the first power state of the vehicle using a vehicle communication interface that is communicatively coupled to a communication bus on the vehicle. The method further includes transmitting a wireless signal corresponding to the first power state from the vehicle communication interface to an aftermarket telematics unit that is electrically connected to the vehicle. The method still further includes altering a second power state of the aftermarket telematics unit to correspond with the first power state when the vehicle communication interface corroborates the first method.

In a still another example, the aftermarket telematics system includes, but is not limited to, an aftermarket telematics unit that is configured for electrical connection to the vehicle. The aftermarket telematics system further includes a vehicle communication interface that is configured for communicative connection to a communication bus on the vehicle. The vehicle communication interface is further configured to be wirelessly communicatively coupled to the aftermarket telematics unit. The vehicle communication interface is further configured to detect a first power state of the vehicle when the vehicle communication interface is communicatively connected to the communication bus and to wirelessly transmit a signal to the aftermarket telematics unit corresponding to the first power state. The aftermarket telematics unit is further configured to alter a second power state of the aftermarket telematics unit in a manner that corresponds with the signal.

### DESCRIPTION OF THE DRAWINGS

One or more examples will hereinafter be described in conjunction with the following drawing figures, wherein like numerals denote like elements, and

FIG. 1 is a schematic view illustrating a non-limiting example of a communication system suitable for use with examples of an aftermarket telematics system made in accordance with the teachings disclosed herein;

FIG. 2 is a schematic view illustrating an exemplary aftermarket telematics system made in accordance with the teachings herein;

FIG. 3 is a block diagram illustrating an exemplary method for controlling an aftermarket telematics unit in accordance with the teachings herein; and

FIG. 4 is a block diagram illustrating another exemplary method for controlling an aftermarket telematics unit in accordance with the teachings herein.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

An improved aftermarket telematics system and an improved method for controlling an aftermarket telematics unit are disclosed herein. The aftermarket telematics system includes an aftermarket telematics unit that is configured to be electrically connected to a vehicle and to draw power from the vehicle's electrical system including its battery and/or alternator.

The aftermarket telematics system also includes a vehicle communication interface that is configured to be communicatively connected with the vehicle's communication bus. For example, the vehicle communications interface may be configured for communicative connection to an Assembly Line Diagnostic Link (hereinafter “ALDL”). An ALDL is a communication port that is typically located at an underside of the vehicle's instrument panel and which provides direct access to the vehicle's communication bus. The ALDL is therefore able to provide the vehicle communications interface with direct access to the communication bus. When communicatively connected to the ALDL (or to any other port that provides access to the communication bus) the vehicle communications interface is configured to monitor the communication bus for message traffic between the various components and/or subsystems of the vehicle. Based on the message traffic detected on the communications bus, or, in some cases, based on the availability of the electric power at the ALDL, the vehicle communication interface is configured to determine whether the vehicle is powered on or powered off.

The vehicle communication interface and the aftermarket telematics unit are configured to wirelessly communicate with one another. Once the vehicle communication interface determines whether the vehicle is powered on or powered off, the vehicle communication interface wirelessly transmits a signal to the aftermarket telematics unit that corresponds with the power state of the vehicle. Upon receipt of the signal, the aftermarket telematics unit is configured to alter its power state to correspond with the power state of the vehicle.

In some examples, the vehicle communication interface may be configured to invoke a specific application state in the aftermarket telematics unit. For instance, if the aftermarket telematics unit is configured to include a theft prevention or recovery state, the vehicle communication interface may be configured to activate such a state.

Although the context of the discussion herein is primarily with regard to aftermarket telematics units, it should be understood to those of ordinary skill in the art that the methods described herein are equally applicable to, and suitable for use with, any type of electronic device that can be communicatively paired (“communicatively paired devices”) with the vehicle communication interface. For example, a smart phone may be communicatively paired via a short range communications protocol with the vehicle communication interface and the vehicle communication interface may be configured to actuate an one or more smart phone applications upon detecting a particular power state of the vehicle.

In still other examples where the vehicle communication interface detects one or more communicatively coupled devices present in the vehicle, the vehicle communication interface may dictate logic for how to communicate data to a cloud network. For example, diagnostic or state data may be sent over a communication network associated with the aftermarket telematics unit or a smart phone or other device using a predetermined application.

A greater understanding of the examples of the aftermarket telematics system and the method for controlling an aftermarket telematics unit disclosed herein may be obtained through a review of the illustrations accompanying this application together with a review of the detailed description that follows.

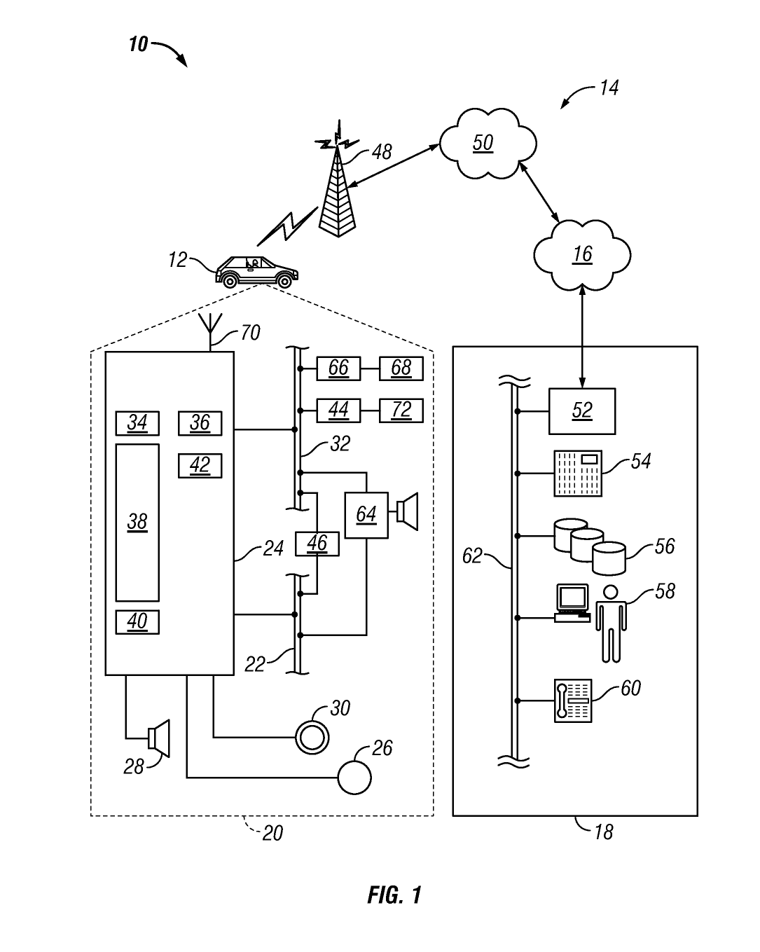

With reference to FIG. 1, there is shown a non-limiting example of a communication system 10 that may be used together with examples of the systems and methods disclosed herein. Communication system 10 generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the methods disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GPS chipset/component 42. In one example, the wireless modem 36 includes a computer program and/or set of software routines adapted to be executed within processing device 38.

The telematics unit 24 may provide various services including: turn-by-turn directions and other navigation-related services provided in conjunction with the GPS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. In order to enable successful data transmission over the voice channel, wireless modem 36 applies some type of encoding or modulation to convert the digital data so that it can be communicated through a vocoder or speech codec incorporated in the cellular chipset/component 34. Any suitable encoding or modulation technique that provides an acceptable data rate and bit error can be used with the present examples. Dual mode antenna 70 services the GPS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more components of the vehicle hardware 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14. For example, a base station and a cell tower could be co-located at the same site or they could be remotely located, and a single base station could be coupled to various cell towers or various base stations could be coupled with a single MSC, to list but a few of the possible arrangements. A speech codec or vocoder may be incorporated in one or more of the base stations, but depending on the particular architecture of the wireless network, it could be incorporated within a Mobile Switching Center or some other network components as well.

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either the advisor 58 or an automated response system, and data transmissions are passed on to a modem or other telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a manned call center 18, it will be appreciated that the call center 18 can be any central or remote facility, manned or unmanned, mobile or fixed, to or from which it is desirable to exchange voice and data.

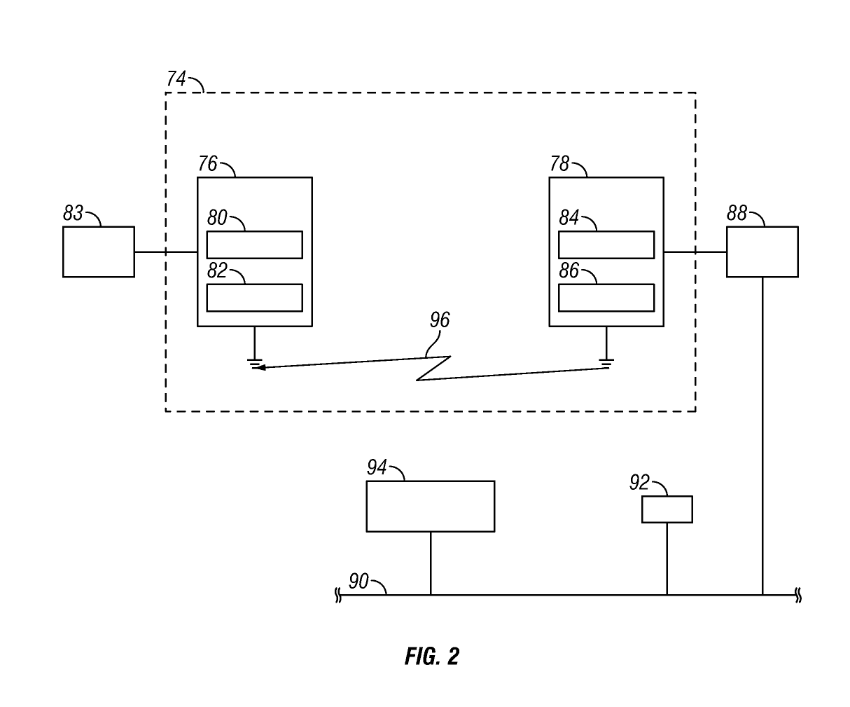

FIG. 2 is a schematic view illustrating an exemplary aftermarket telematics system 74 made in accordance with the teachings herein. Aftermarket telematics system 74 includes an aftermarket telematics unit 76 and a vehicle communications interface 78.

With continuing reference to FIGS. 1-2, aftermarket telematics unit 76 is a self contained telematics unit that is compatible with communication system 10 and that is configured to provide many, if not all, of the services provided by telematics unit 24 which is embedded in vehicle 12. Aftermarket telematics unit 76 may be purchased and installed into vehicle 12 after vehicle 12 has been assembled by the original equipment manufacturer. The use of an aftermarket telematics unit together with a communication system such as communication system 10 is disclosed and described in pending U.S. patent applications Ser. No. 12/548,148 filed on Aug. 26, 2009 and Ser. No. 12/683,040 filed on Jan. 6, 2010. These pending U.S. patent applications are hereby incorporated herein by reference in their entirety. Aftermarket telematics units of the sort discussed herein are disclosed and described in a pending U.S. patent application Ser. No. 12/787472 filed on May 26, 2010, and also in U.S. Publication No. 2005/0273211 published on Dec. 8, 2005, each of which is hereby incorporated herein by reference in its entirety.

In the illustrated example, aftermarket telematics unit 76 includes a processor 80 and the transceiver 82. Processor 80 may be any type of computer, computer system, microprocessor, collection of logic devices such as field-programmable gate arrays (FPGA), or any other analog or digital circuitry that is configured to calculate, and/or to perform algorithms, and/or to execute software applications, and/or to execute sub-routines, and/or to be loaded with and to execute any type of computer program. Processor 80 may comprise a single processor or a plurality of processors acting in concert.

Transceiver 82 may be any type of wireless transceiver including a transceiver that is configured to communicate via radio frequency transmissions, infra red transmissions, or via any other wireless transmission effective to communicate a signal. In other examples of aftermarket telematics unit 76, a wireless transmitter and a wireless receiver may be used in lieu of a single device such as transceiver 82.

Processor 80 is operatively coupled to transceiver 82 and is configured to utilize transceiver 82 to communicate wirelessly with vehicle communication interface 78. Transceiver 82 may send wireless signals to, and may receive wireless signals from vehicle communication interface 78. Transceiver 82 is further configured to forward any wireless signal received from vehicle communication interface 78 to processor 80.

Aftermarket telematics unit 76 is configured for electrical connection to, and to draw electrical power from, an electrical system 83 of vehicle 12. For example, aftermarket telematics unit 76 may be connected via wires to a 12 V battery (not shown) on vehicle 12. In other examples, aftermarket telematics unit 76 may be connected via wires to an alternator (not shown) on vehicle 12. In still other examples, aftermarket telematics unit 76 may be connected to both the 12 V battery and the alternator on vehicle 12 and the alternate receiving power from these components depending upon the power state of vehicle 12. Connection to other sources of electricity on vehicle 12 are also possible.

Aftermarket telematics unit 76 may be configured to operate in one of three modes. Aftermarket telematics unit 76 may operate in an on-mode wherein all or substantially all of its subsystems and components are powered on. Aftermarket telematics unit 76 is configured to operate in the on-mode whenever vehicle 12 is powered on. While in the on-mode, aftermarket telematics unit 76 will draw the most power from electrical system 83. Aftermarket telematics unit 76 is also configured to operate in a standby-mode. While in the standby-mode, most of its subsystems are powered down. Aftermarket telematics unit 76 is configured to operate in the standby-mode whenever vehicle 12 is powered off for short or intermediate amounts of time (e.g., for periods of time not exceeding 120 hours). When in standby-mode, aftermarket telematics unit 76 can readily be awakened (i.e., return to the on-mode) when vehicle 12 is powered on. Operation in the standby-mode greatly reduces the power drawn by aftermarket telematics unit 76 on electrical system 83. Aftermarket telematics unit 76 may also operate in an off-mode wherein substantially all subsystems of aftermarket telematics unit 76 have been powered off. Aftermarket telematics unit 76 may enter the off-mode whenever vehicle 12 has been powered off for extended periods of time (e.g., greater than 120 hours). While in the off-mode, aftermarket telematics unit 76 draws the least amount of power from electrical system 83.

Vehicle communication interface 78 may be any device adapted for communicative coupling to a vehicle's communication bus and configured for communication with some or all of the vehicle subsystems and components that are connected to the vehicle's communication bus. Vehicle communications interface 78 is also configured for wireless communication with aftermarket telematics unit 76. Vehicle communication interface devices that are suitable to serve as vehicle communication interface 78 are known in the art. An example of a vehicle communication interface suitable for use with aftermarket telematics system 74 is an ecoRoute™ HD, offered by Garmin under the part number 010-11380-00.

Vehicle communication interface 78 includes a processor 84 and a transceiver 86. Processor 84 may be any type of computer, computer system, microprocessor, collection of logic devices such as field-programmable gate arrays (FPGA), or any other analog or digital circuitry that is configured to calculate, and/or to perform algorithms, and/or to execute software applications, and/or to execute sub-routines, and/or to be loaded with and to execute any type of computer program. Transceiver 86 may be any type of wireless transceiver including transceiver is configured to communicate via radio frequency transmissions, infra red transmissions, or via any other wireless transmission effective to communicate a signal. In some examples, rather than using a single device such as transceiver 86, vehicle communications interface 78 may include a wireless transmitter and a separate wireless receiver.

Vehicle communication interface 78 is configured for coupling to ALDL 88. ALDL 88 is an assembly line diagnostics link that provides vehicle communication interface 78 with a communicative connection to communication bus 90. Communication bus 90 resides within vehicle 12 and serves as a communication corridor between numerous vehicle subsystems such as body control module 92 and transmission control module 94. Many other vehicle components and subsystems may also be connected to communication bus 90. Processor 84 is configured to communicate with the numerous vehicle subsystems connected to communication bus 90. Processor 84 may be configured to monitor such subsystems and, in some cases, may also be configured to send messages, instructions, and or queries to such subsystems. In addition to providing vehicle communication interface 78 with a communicative pathway to communication bus 90, in many vehicles, the ALDL is electrified and thus vehicle communication interface 78 may draw power from ALDL 88.

Aftermarket telematics unit 76 and vehicle communication interface 78 are configured to utilize transceiver's 82 and 86, respectively to communicate with one another via a short range wireless communication protocol. For example, and without limitation, aftermarket telematics unit 76 and vehicle communication interface 78 may be configured to communicate with one another via a Bluetooth™ communication network. In some examples, aftermarket telematics unit 76 and vehicle communication interface 78 may be communicatively paired with one another. As used herein, the term “communicatively paired” means that each device is configured to detect the presence/availability of the other device and, once detected, to form a communication link with the other device wherein each device will wirelessly communicate only with the other device of the pair. In some examples, communicatively paired devices may communicate with one another in an encrypted or otherwise secure fashion. In some examples, aftermarket telematics unit 76 and vehicle communication interface 78 are each configured such that when both devices are powered on (e.g., when aftermarket telematics unit 76 operates in the on-mode), they will automatically pair with one another once each detects the presence of the other.

Vehicle communication interface 78 is configured to determine the power state of vehicle 12 by monitoring communications bus 90. In some examples, when a vehicle is powered off, all message traffic transmitted across communications bus 90 will cease. Accordingly, if vehicle communication interface 78 detects a sudden change in message traffic across communications bus 90 from a state where no messages are being transmitted to a state where multiple messages are being transmitted, vehicle communications interface 78 is configured to determine that vehicle 12 has just been powered on. Conversely, if vehicle communication interface 78 detects a sudden change in message traffic across communications bus 90 from a state where multiple messages are being transmitted to a state where no messages are being transmitted, vehicle communications interface 78 is configured to determine that vehicle 12 has just been powered off. In this manner, vehicle communications interface 78 is configured to rely on the presence or absence of generic message traffic across communication bus 90 when determining whether vehicle 12 is powered on or power off

In other examples, vehicle communication interface 78 may be configured to monitor communication bus 90 and may be further configured to determine the power state of vehicle 12 based on the transmission of specific messages that are communicated across communication bus 90 by specific vehicle components and/or subsystems. Some messages are only transmitted when the vehicle is powered on. For example, when a driver turns vehicle 12 on, body control module 92 may transmit an awaken command to multiple subsystems of vehicle 12 across communication bus 90. Vehicle communication interface 78 may determine that vehicle 12 is on when the awaken command is detected. In another example, transmission control module 94 may transmit a transmission state of vehicle 12 across communication bus 90 each time the transmission changes from one state to the next. For example, a vehicle transmission may commonly be placed in one of park, reverse, neutral, drive, and low by the driver. Transmission control module 94 may be configured to send a corresponding message across communication bus 90 each time the transmission state of vehicle 12 changes. Changes in the transmission from one state to the next are generally indicative of the vehicle being powered on. Accordingly, the vehicle communications interface 78 may be configured to determine the power state of vehicle 12 based on its detection of a message on communication bus 90 corresponding to the transmission state of vehicle 12.

In still other examples, vehicle 12 may be configured to supply electric power to ALDL 88 only when vehicle 12 is powered on. In such examples, vehicle communication interface 78 may be configured to determine that vehicle 12 is powered on whenever electric power is available through ALDL 88 and that vehicle 12 is powered off whenever electric power is not available through ALDL 88. Thus, a change of ALDL 88 from an electrified state to a non-electrified state or vice versa could be an indication that the power state of the vehicle has changed.

When vehicle communications interface 78 determines that a change has occurred in the power state of vehicle 12, vehicle communication interface 78 is configured to send a signal 96 to aftermarket telematics unit 76. Signal 96 will correspond with the power state of vehicle 12. For example, signal 96 may directly communicate the power state of vehicle 12 to aftermarket telematics unit 76. In such examples, when aftermarket telematics unit 76 receives signal 96 indicating that vehicle 12 is powered on, aftermarket telematics unit 76 will change its power state from either the off-mode or the standby-mode to the on-mode. Conversely, when aftermarket telematics unit 76 receives signal 96 indicating that vehicle 12 is powered off, aftermarket telematics unit 76 will alter its power state and enter the standby-mode (or in some cases, the off-mode).

In other examples, signal 96 may comprise an instruction to turn on or turn off, depending on the power state of vehicle 12. For example, if vehicle communication interface 78 detects that vehicle 12 has just powered on, then signal 96 may be an instruction for aftermarket telematics unit 76 to turn on. If vehicle communication interface 78 detects that vehicle 12 has just powered off, then signal 96 may be an instruction for aftermarket telematics unit 76 to enter standby-mode. Aftermarket telematics unit 76 will alter its power state to the on-mode or the standby-mode when it receives signal 96 containing an instruction to either turn on or turn off, respectively.

In other examples, signal 96 may contain a reiteration of the specific message that vehicle communication interface 78 detected on communication bus 90. For example, signal 96 may contain a message the vehicle 12 has just been placed in drive. In such examples, aftermarket telematics unit 76 may be configured to determine the power state of vehicle 12 from the information encoded in signal 96.

In examples where vehicle 12 supplies electric power to ALDL 88 only when vehicle 12 is powered on, then signal 96 may comprise either the initiation of, or the cessation of a communication pairing between vehicle communication interface 78 and aftermarket telematics unit 76. The powering on a vehicle 12 may cause the electrification of ALDL 88. The electrification of ALDL 88 may, in turn, caused vehicle communication interface 78 to power on. This would result in the initiation of communicative pairing between vehicle communication interface 78 and aftermarket telematics unit 76. Thus, the initiation of communicative pairing between vehicle communication interface 78 and aftermarket telematics unit 76 would serve as a signal to aftermarket telematics unit 76 that vehicle 12 has been powered on. Accordingly, once aftermarket telematics unit 76 detects that it is communicatively paired with the vehicle communications interface 78, aftermarket telematics unit 76 will alter its power state by entering the on-mode. Conversely, the cessation of communication pairing between vehicle communication interface 78 and aftermarket telematics unit 76 may indicate that vehicle 12 is powered off. Accordingly, when aftermarket telematics unit 76 detects that it is no longer communicatively paired with the vehicle communication interface 78, aftermarket telematics unit 76 will alter its power state by entering the standby-mode. In still other examples, signal 96 may contain any other suitable instruction that effectively corresponds with the power state of vehicle 12.

Once aftermarket telematics unit 76 has changed its power state to correspond with the power state of vehicle 12, aftermarket telematics unit 76 may be configured to remain in that power state until another signal is received indicating a further change in the power state of vehicle 12. In some examples, aftermarket telematics unit 76 may be configured to interrogate vehicle communication interface 78 to determine the current power state of vehicle 12. For example, in some examples, aftermarket telematics unit 76 may be configured to interrogate vehicle communication interface 78 after a predetermined number of hours of continuous operation in the same power state.

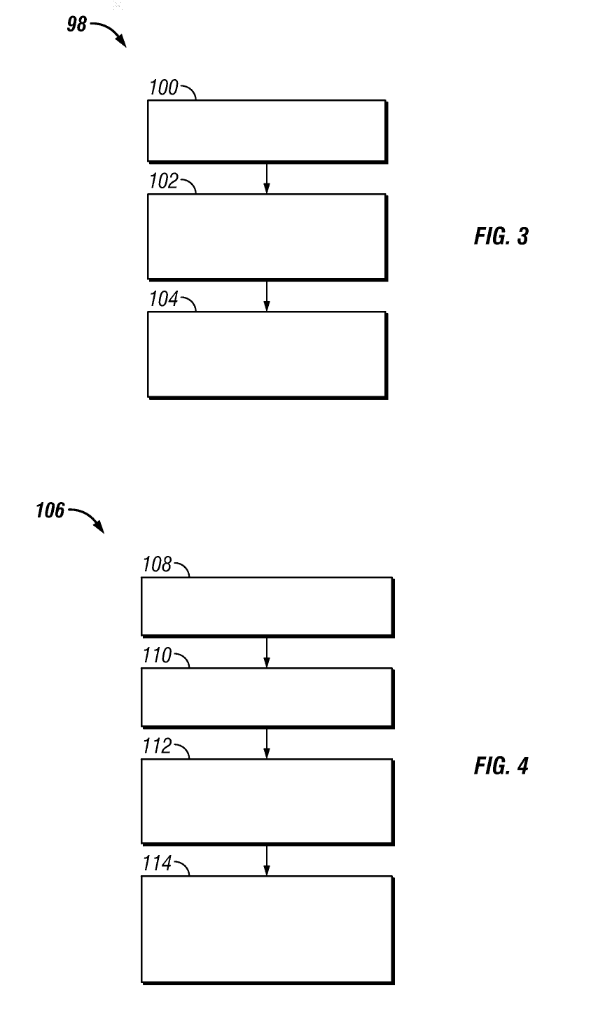

FIG. 3 is a block diagram illustrating an exemplary method 98 for controlling an aftermarket telematics unit. With continuing reference to FIGS. 1-3, in an example, method 98 may be implemented using aftermarket telematics system 74 to control the power state of aftermarket telematics unit 76.

At block 100 the power state of a vehicle is detected using a vehicle communication interface such as a vehicle communication interface 78. The vehicle communication interface is communicatively coupled to a communication bus on the vehicle and is configured to determine the power state of the vehicle by monitoring the communication bus. For example, if generic message traffic is detected between various components that are communicating with one another over the communication bus, then the vehicle communication interface may be configured to determine that the vehicle is powered on. In another example, the vehicle communication interface may determine the power state of the vehicle when it detects specific message traffic on the communication bus. For instance, if an awaken command is communicated by the vehicle's body control module, or if a command is transmitted by the vehicle's transmission control module indicative of a transmission state of the vehicle, then the vehicle communication interface may determine the vehicle is powered on. These examples are not exhaustive and are not intended to be limited. It should be understood that the vehicle communication interface may be configured to monitor the vehicle's communication bus for any signal or indication that is indicative of the vehicle's power state and to determine the power state of the vehicle based on such signal or indication.

At block 102, the vehicle communication interface transmits a wireless signal to an aftermarket telematics unit (such as aftermarket telematics unit 76) that is electrically connected to the vehicle. The wireless signal is indicative of the power state of the vehicle. For instance, the wireless signal may be a command to the aftermarket telematics unit to enter an on-mode or a standby-mode. In another example, the wireless signal may contain a message indicating the current power state of the vehicle. In examples where the aftermarket telematics unit and the vehicle communication interface are communicatively paired with one another, then the signal may comprise the initiation of, or the cessation of the communicative pairing. This last example may be implemented in situations where the vehicle is configured to provide power to the vehicle communication interface over an ALDL or via some other means only when the vehicle is powered on.

At block 104, the aftermarket telematics unit alters its power state in a manner that corresponds with the power state of the vehicle. In one example, if the vehicle is powered off, then the aftermarket telematics unit will enter either a standby-mode or an off-mode. If the vehicle is powered on, the aftermarket telematics unit will enter an on-mode.

FIG. 4 is a block diagram illustrating another method 106 for controlling an aftermarket telematics unit. Method 106 is similar to method 98 of FIG. 3, the primary difference being that method 106 utilizes method 98 to corroborate a determination of the power state of the vehicle that has been made using a different method, one which does not involve monitoring the vehicle's communication bus.

At block 108, the power state of the vehicle is determined using a first method. The first method may be any existing or conventional method for determining the power state of the vehicle. For example, one method of determining the power state of the vehicle entails monitoring the vehicle's battery for spikes and/or drops in voltage. This method is disclosed in a co-pending patent application having the Ser. No. 12/845,822, filed on Jul. 29, 2010, the disclosure of which is hereby incorporated herein in its entirety by reference.

At block 110, the power state of the vehicle is determined using a vehicle communication interface that is communicatively connected to the vehicle's communication bus. The determination of the vehicle's power state by the vehicle communication interface has been described in detail above and, for the sake of brevity, will not be repeated here.

At block 112, the vehicle communication interface transmits a wireless signal to an aftermarket telematics unit that is electrically connected to the vehicle. The wireless signal corresponds to the power state of the vehicle as determined by the vehicle communications interface.

At block 114, the aftermarket telematics unit will alter its own power state in a manner that corresponds to the power state of the vehicle when the power state of the vehicle as determined by the vehicle communication interface corroborates (i.e., confirms) the power state of the vehicle as determined by the first method. In some examples, the corroboration comprise comparing the power state of the vehicle as determined by the first method with the power state of the vehicle as determined by the vehicle communications interface to determine if they are the same. In some examples, this comparison may be undertaken by a processor of the aftermarket telematics unit, a processor in the vehicle communications interface, or a processor located elsewhere in the vehicle.

While at least one exemplary example has been presented in the foregoing detailed description, it should be appreciated that a vast number of variations exist. It should also be appreciated that the exemplary example or exemplary examples are only examples, and are not intended to limit the scope, applicability, or configuration in any way. Rather, the foregoing detailed description will provide those skilled in the art with a convenient road map for implementing the exemplary example or exemplary examples. It should be understood that various changes can be made in the function and arrangement of elements without departing from the scope as set forth in the appended claims and the legal equivalents thereof.

What is claimed is:

1. A method for controlling a communicatively paired device for use with a vehicle, the method comprising:
detecting a first power state of the vehicle using a vehicle communication interface (VCI) that is communicatively coupled to a communication bus on the vehicle;
transmitting a wireless signal corresponding to the first power state from the VCI to a communicatively paired device; and
altering a second power state of the communicatively paired device to correspond with the first power state.

2. The method of claim 1, wherein the detecting step comprises detection by the VCI of generic message traffic on the communication bus.

3. The method of claim 1, wherein the detecting step comprises detection by the VCI of a specific message communicated on the communication bus.

4. The method of claim 3, wherein detection by the VCI of the specific message comprises detection by the VCI of an awaken command sent by a body control module of the vehicle.

5. The method of claim 3, wherein detection by the VCI of the specific message comprises detection by the VCI of a message sent by a powertrain module of the vehicle relating to a transmission state of the vehicle.

6. The method of claim 5, wherein the detection by the VCI of the message sent by the powertrain module comprises detection by the VCI of the message indicating that the transmission state is one of a park, reverse, neutral, drive, and low.

7. The method of claim 1, wherein the VCI is electrically connected to an assembly line diagnostic link (“ALDL”) port on the vehicle, wherein the ALDL port only supplies electric power to the VCI when the vehicle is on, and wherein the detecting step comprises detection by the VCI of electrical power being supplied by the ALDL port.

8. The method of claim 7, wherein the VCI and the communicatively paired device are configured to be communicatively paired with one another when the VCI and the communicatively paired device are each connected to the vehicle and each are powered on, and wherein the transmitting step comprises discontinuation of the communicative pairing between the VCI and the communicatively paired device.

9. The method of claim 1, wherein the altering step comprises turning the communicatively paired device to and on-mode when the vehicle is powered on and turning the communicatively paired device to a standby-mode when the vehicle is powered off

10. A method for controlling a telematics unit for use with a vehicle, the method comprising:
detecting a first power state of the vehicle using a first method;
detecting the first power state of the vehicle using a VCI that is communicatively coupled to a communication bus on the vehicle;
transmitting a wireless signal corresponding to the first power state from the VCI to an ATU that is electrically connected to the vehicle; and
altering a second power state of the ATU to correspond with the first power state when the VCI corroborates the first method.

11. The method of claim 10, wherein the step of detecting the first power state of the vehicle using the first method comprises monitoring with the ATU a battery connected to the vehicle for a fluctuation in voltage and determining the first power state of the vehicle based on the fluctuation.

12. The method of claim 10, wherein the step of detecting the first power state of the vehicle using the VCI comprises detection by the VCI of generic message traffic on the communication bus.

13. The method of claim 10, wherein the step of detecting the first power state of the vehicle using the VCI comprises detection by the VCI of a specific message communicated on the communication bus.

14. The method of claim 13, wherein detection by the VCI of the specific message comprises detection by the VCI of an awaken command sent by a body control module of the vehicle.

15. The method of claim 13, wherein detection by the VCI of the specific message comprises detection by the VCI of a message sent by a powertrain module of the vehicle relating to a transmission state of the vehicle.

16. The method of claim 15, wherein detection by the VCI of the message by the powertrain module comprises detection by the VCI of the message indicating that the transmission state is one of a park, reverse, neutral, drive, and low.

17. The method of claim 10, wherein the VCI is electrically connected to an ALDL port on the vehicle, wherein the ALDL port only supplies electric power to the VCI when the vehicle is on, and wherein the step of detecting the first power state using the VCI comprises detection by the VCI of electrical power being supplied by the ALDL port.

18. The method of claim 17, wherein the VCI and the ATU are configured to be communicatively paired with one another when the VCI and the ATU are each connected to the vehicle and each are powered on, and wherein the transmitting step comprises discontinuation of the communicative pairing between the VCI and the ATU.

19. The method of claim 10, wherein the altering step comprises turning the ATU to an on-mode when the vehicle is powered on and turning the ATU to a standby-mode when the vehicle is powered off.

20. An aftermarket telematics system for use with a vehicle, the aftermarket telematics system comprising:
an aftermarket telematics unit (“ATU”) configured for electrical connection to the vehicle; and
a vehicle communication interface (“VCI”) configured for communicative connection to a communication bus on the vehicle, the VCI further configured to be wirelessly communicatively coupled to the ATU;
wherein the VCI is further configured to detect a first power state of the vehicle when the VCI is communicatively connected to the communication bus and to wirelessly transmit a signal to the ATU corresponding to the first power state, and wherein the ATU is further configured to alter a second power state of the ATU in a manner that corresponds with the signal.
